(19) United States
(12) Patent Application Publication
(10) Pub. No.: US 2023/0153428 A1
(43) Pub. Date: May 18, 2023

(54) INFORMATION PROCESSING DEVICE, INFORMATION PROCESSING METHOD, RECORDING MEDIUM, INFORMATION PROCESSING SYSTEM

(71) Applicant: NEC Corporation, Minato-ku, Tokyo (JP)

(72) Inventors: Shohei Mitani, Tokyo (JP); Naoki Yoshinaga, Tokyo (JP)

(73) Assignee: NEC Corporation, Minato-ku, Tokyo (JP)

(21) Appl. No.: 17/913,235

(22) PCT Filed: Mar. 30, 2020
(86) PCT No.: PCT/JP2020/014560

§ 371 Date: Sep. 21, 2022

(51) Int. Cl. G06F 21/55

(52) U.S. Cl. CPC G06F 21/554; G06F 21/552

(57) ABSTRACT

A plurality of event types associated with a plurality of events which emerge in the future with high emergence probability is selected by use of event series representing at least multiple types of events output from a target system in the past time interval and output times of events and a selection model configured to select event types to emerge in the future with high emergence probability among multiple types of events included in the event series. An order of the selected events to emerge in the future and time intervals therebetween are predicted by use of the selected event types and a series prediction model configured to estimate the order of the selected events to emerge in the future and the time intervals therebetween.

### TECHNICAL FIELD

The present invention relates to an information processing device, an information processing method, a recording medium, and an information processing system.

### BACKGROUND ART

Information processing systems have been extensively used in various fields. On the other hand, information processing systems have frequently faced threats of high-degree attacks such as targeted attacks from exterior devices. For the purpose of preventing attacks, OT (Operational Technology) systems for controlling physical systems such as plants and important infrastructures should monitor a series of events such as control procedures and traffic data of network systems as well as process data of physical systems by use of computer devices. Computer-aided monitoring has been performed to detect abnormal behaviors such as attacks against systems and failures of systems. Herein, events can be defined as data output from computer devices or other electronic devices constituting systems or systems themselves. In addition, event series can be defined as data groups output from computer devices, other electronic devices, or systems in a time-series manner.

For the purpose of detecting abnormality in systems, for example, Patent Document 1 discloses a technology of learning orders of control instructions (or control commands) and time intervals therebetween in advance, setting a certain allowable range, and detecting abnormality in a series of control commands deviated from the allowable range.

Patent Document 2 discloses a methodology of extracting frequent patterns from event logs via pattern mining and detecting abnormal event series using prediction models having completed learning in advance. The technology of Patent Document 2 is designed to stochastically predict whether frequent patterns actually emerge in event series of former frequent patterns (partial patterns) and to thereby detect abnormal event series even in systems which might make a mixture of multiple event series.

Patent Documents 3 discloses a methodology adapted to the status of systems including physical systems and configured to store a plurality of whitelists mentioning allowed communications in network systems and to thereby detect attacks or abnormality which cannot be detected by a single whitelist.

### CITATION LIST

### Patent Literature Document

Patent Document 1: Japanese Patent Application Publication No. 2018-022296
Patent Document 2: Japanese Patent Application Publication No. 2018-045403
Patent Document 3: International Publication WO2018/134939

### SUMMARY OF INVENTION

### Technical Problem

All the aforementioned technologies disclosed in Patent Document 1, Patent Document 2, and Patent Document 3 are technologies configured to detect abnormality in regular event series when computer devices or other electronic devices constituting systems or systems themselves may normally output regular events. For example, it is not possible to identify regular event series when multiple event series are mixed irregularly or when event series may differently emerge according to the status of systems including physical systems.

For this reason, the present invention aims to provide an information processing device, an information processing method, a recording medium, and an information processing system.

### Solution to Problem

According to a first aspect of the present invention, an information processing device adopts a relevant-event selection means configured to use event series representing at least multiple types of events output from a target system in the past time interval and output times of events and a selection model configured to select event types to emerge in the future with high emergence probability among multiple types of events included in the event series and to thereby select a plurality of event types associated with a plurality of events which emerge in the future with the high emergence probability from among the multiple types of events included in the event series, thus predicting an order of the selected events to emerge in the future and time intervals therebetween by use of the selected event types and a prediction model configured to estimate the order of the selected events to emerge in the future and the time intervals therebetween.

According to a second aspect of the present invention, an information processing method includes the steps of: by use of event series representing at least multiple types of events output from a target system in the past time interval and output times of events and a selection model configured to select event types to emerge in the future with high emergence probability among multiple types of events included in the event series, selecting a plurality of event types associated with a plurality of events which emerge in the future with high emergence probability from among multiple types of events included in the event series; and predicting an order of the selected events to emerge in the future and time intervals therebetween by use of the selected event types and a prediction model configured to estimate the order of the selected events to emerge in the future and the time intervals therebetween.

According to a third aspect of the present invention, a program causes a computer of an information processing device to function as: a relevant-event selection means configured to use event series representing at least multiple types of events output from a target system in the past time interval and output times of events and a selection model configured to select event types to emerge in the future with high emergence probability among multiple types of events included in the event series and to thereby select a plurality of event types associated with a plurality of events which emerge in the future with high emergence probability from among multiple types of events included in the event series; and a prediction means configured to predict an order of the selected events to emerge in the future and time intervals therebetween by use of the selected event types and a prediction model configured to estimate the order of the selected events to emerge in the future and the time intervals therebetween.

### Advantageous Effects of Invention

According to the present invention, it is possible to monitor abnormality in events even when computer devices or other electronic devices constituting systems or systems themselves may output irregular events.

### BRIEF DESCRIPTION OF DRAWINGS

FIG. 1 is a block diagram showing a functional configuration of an information processing device according to one exemplary embodiment of the present invention.

FIG. 2 is a block diagram showing a functional configuration of a learning unit installed in the information processing device according to one exemplary embodiment of the present invention.

FIG. 3 is a first diagram showing an example of input data of the information processing device according to one exemplary embodiment of the present invention.

FIG. 4 is a first schematic showing an outline of processing of the information processing device according to one exemplary embodiment of the present invention.

FIG. 5 is a second diagram showing another example of input data of the information processing device according to one exemplary embodiment of the present invention.

FIG. 6 is a first flowchart showing a flow of processing of the information processing device according to one exemplary embodiment of the present invention.

FIG. 7 is a block diagram showing an outline of processing of the learning unit according to one exemplary embodiment of the present invention.

FIG. 8 is a graph showing the relationship between processing states and event series.

FIG. 9 is a block diagram showing an outline of processing of the learning unit according to one exemplary embodiment of the present invention.

FIG. 10 is a second flowchart showing a flow of processing of the information processing device according to one exemplary embodiment of the present invention.

FIG. 11 is a first block diagram showing an outline of processing in a monitoring process according to one exemplary embodiment of the present invention.

FIG. 12 is a second block diagram showing an outline of processing in a monitoring process according to one exemplary embodiment of the present invention.

FIG. 13 includes a pair of tables shoring the relationship between a whitelist and an event set in a first process state according to one exemplary embodiment of the present invention.

FIG. 14 includes a pair of tables showing the relationship between a whitelist and an event set in a second process state according to one exemplary embodiment of the present invention.

FIG. 15 includes a pair of tables showing the relationship between a whitelist and an event set in a third process state according to one exemplary embodiment of the present invention.

FIG. 16 is a block diagram showing an example of a monitoring process whose determination result indicates normality according to one exemplary embodiment of the present invention.

FIG. 17 is a block diagram showing an example of a monitoring process whose determination result indicates abnormality according to one exemplary embodiment of the present invention.

FIG. 18 is a block diagram showing a minimum configuration of an information processing device according to one exemplary embodiment of the present invention.

FIG. 19 is a flowchart showing a flow of processing of the information processing device having the minimum configuration according to one exemplary embodiment of the present invention.

### DESCRIPTION OF EXEMPLARY EMBODIMENTS

Hereinafter, an information processing device according to one exemplary embodiment of the present invention will be described with reference to the accompanying drawings.

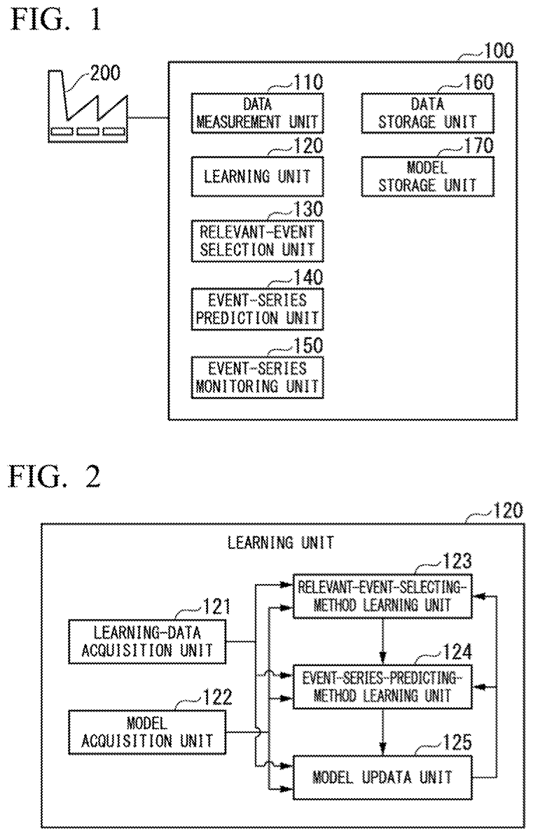

FIG. 1 is a block diagram showing the functional configuration of the information processing device.

According to the present invention, an information processing device 100 is connected to an information processing system 200 for controlling a plant or the like serving as a control subject. The information processing device 100 is used to monitor the information processing system 200. Any devices or equipment constituting the information processing system 200 may output communication packets for controlling a control subject such as a plant over communication networks constituting the information processing system 200. The information processing device 100 is configured to acquire communication packets, thus monitoring the information processing system 200.

The information processing device 100 is constituted by one or multiple information processing devices each including an operation device and a storage device. When the operation device executes programs, the information processing device 100 may realize various functions as shown in FIG. 1 such as a data measurement unit 110, a learning unit 120, a relevant-event selection unit 130, an event-series prediction unit 140, and an event-series monitoring unit 150. In addition, the information processing device 100 includes a data storage unit 160 and a model storage unit 170 which are formed in the storage device.

FIG. 2 is a block diagram showing the functional configuration of a learning unit installed in an information processing device.

The learning unit 120 includes various functional configurations such as a learning-data acquisition unit 121, a model acquisition unit 122, a relevant-event-selecting-method learning unit 123, an event-series-predicting-method learning unit 124, and a model update unit 125.

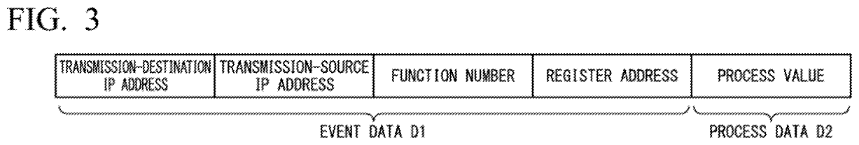

FIG. 3 is a first diagram showing one example of input data of an information processing device.

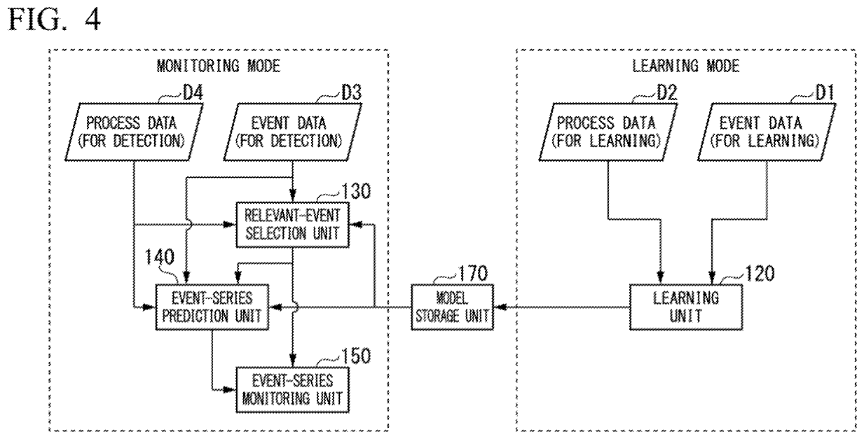

FIG. 4 is a first schematic showing an outline of processing of an information processing device.

The information processing device 100 acquires communication packets output from the information processing system 200 so as to record communication packets in a database thereof or the like. In a learning process, the information processing device 100 acquires event data D1 and process data D2 which are determined according to communication packets. The learning unit 120 of the information processing device 100 inputs multiple types of events selected, time intervals among times of emerging events, and the status information output from the information processing system 200 in time intervals so as to generate by machine learning a relevant-event-selecting model configured to output an event type having high relevancy among multiple types of events output from the information processing system 200 in time intervals. The learning process is performed by the relevant-event-selecting-method learning unit 123. The information processing device 100 records the relevant-event-selecting model on the model storage unit 170.

The learning unit 120 performs the learning process based on the event data D1 and the process data D2 included in past communication packets and new communication packets. The learning unit 120 performs the learning process to learn a series prediction model according to the result of prediction using the series prediction model including time intervals and the order in which the selected events emerge in the future in order to increase a prediction-accuracy value which can be obtained using a matching degree relating to the order of events of the selected type emerging in time intervals in the future and a matching degree between time intervals in the future and time intervals based on emerging times of events. The learning process is performed by the event-series-predicting-method learning unit 124. The information processing device 100 records the series prediction model on the model storage unit 170.

The event data includes an acquisition time of a communication packet as well as various pieces of information included in the communication packet such as a transmission-destination IP address, a transmission-source IP address, a function number, and a register address. The event data further includes an event type which is classified according to a combination of the transmission-destination IP address, the transmission-source IP address, the function number, and the register address included in the communication packet. In addition, the process data includes a process value included in the communication packet. For example, the process value is a measurement value measured by a physical sensor relative to a control subject. When the control subject is a plant, for example, the process value may be temperature, humidity, pressure, the number of revolutions, or other values acquired from the physical sensor by each device or equipment of a plant.

The information processing device 100 performs a monitoring process using a relevant-event-selecting model and a series prediction model as well as past communication packets and new communication packets which occur in the monitoring process of the information processing system 200. In the monitoring process, the information processing device 100 determines whether abnormality occurs in a time-series of communication packets newly acquired.

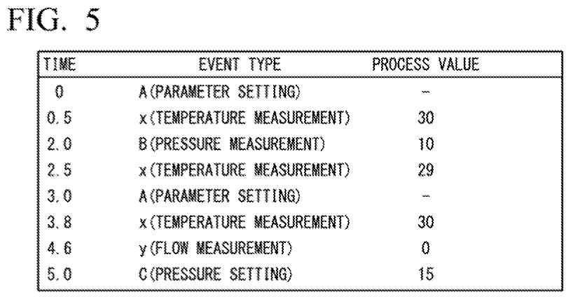

FIG. 5 is a second diagram showing another example of input data of the information processing device.

The data measurement unit 110 of the information processing device 100 acquires event data and process data based on communication packets acquired from the information processing system 200. The information processing device 100 identifies an event type (A,B,C,x,y) according to a combination of the transmission-destination IP address, the transmission-source IP address, the function number, and the register number included in a communication packet, thus storing the event data, the process data (or a process value), the event type, and the reception time in association with each other. Base on the reception time and the event type, the data measurement unit 110 of the information processing device 100 may statistically calculate event-data-processing values such as an event interval representing a time interval in which the information processing system 200 outputs a communication packet designated by the event type and an event frequency representing the frequency for outputting the communication packet. In addition, the measurement unit 110 of the information processing device 100 may calculate process-data-processing values each representing a differential value or an integral value of a process value output from the information processing system 200 based on the reception time and the process value. The data measurement unit 110 may record on the data storage unit 160 the event-data-processing value and the process-data-processing value calculated above in association with the event data and the process data.

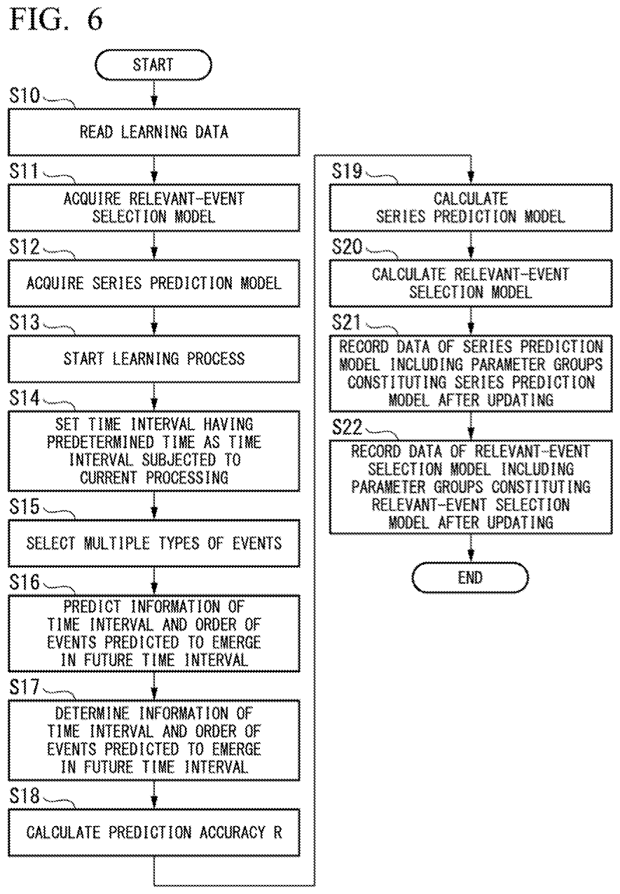

FIG. 6 is a first flowchart showing a flow of processing of the information processing device.

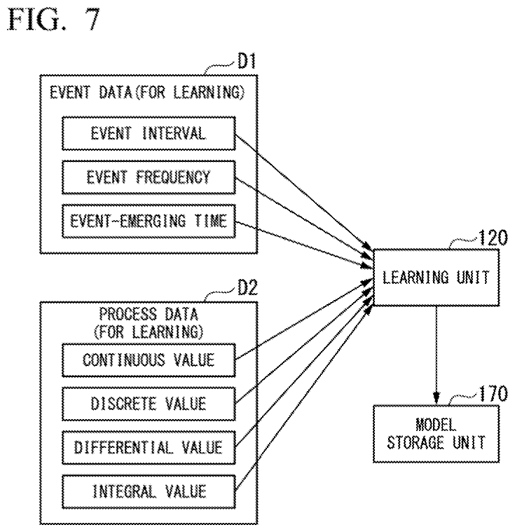

FIG. 7 is a block diagram showing an outline of processing of the learning unit.

Hereinafter, the processing of the information processing device 100 will be described in detail.

First, the information processing device 100 is configured to perform a learning process. In the learning unit 120 of the information processing device 100, the learning-data acquisition unit 121 first reads learning data from the data storage unit 160 (step S10). As shown in FIG. 7, the learning-data acquisition unit 121 reads learning data including event data, process data, process values of event data, process values of process data stored on the database thereof. The learning-data acquisition unit 121 acquires event data, process data, process values of event data (e.g., event intervals, event frequency, and event-emerging times), and process values of process data (e.g., continuous values, discrete values, differential values, integral values of process values). The learning-data acquisition unit 121 sequentially acquires event data, process data, process values of event data, and process values of process data responsive to acquirement of communication packets by the data measurement unit 110 and recording of event data, process data, process values of event data, and process values of process data corresponding to communication packets on the data storage unit 160. The learning-data acquisition unit 121 acquires and output the above data to the relevant-event-selecting-method learning unit 123. In addition, the learning-data acquisition unit 121 acquires and outputs the above data to the event-series-prediction-method learning unit 124.

The model acquisition unit 122 acquires from the model storage unit 170 a relevant-event-selecting model in its initial condition or in the middle of learning (step S11). The model acquisition unit 122 acquires from the model storage unit 170 a series-predicting model in its initial condition or in the middle of learning (step S12). The model acquisition unit 122 acquires and outputs the relevant-event-selecting model to the relevant-event-selecting-method learning unit 123. In addition, the model acquisition unit 122 acquires and outputs the series-predicting model to the event-series-predicting-method learning unit 124. The relevant-event-selecting-method learning unit 123 starts to perform a learning process (step S13).

The relevant-event-selecting-method learning unit 123 sets a certain time interval having a predetermined time in the past as a time interval for a current subject of processing (step S14). The relevant-event-selecting-method learning unit 123 acquires event data and process data included in communication packets output from the information processing system 200 in the time interval having the predetermined time in the past. For example, the time interval having the predetermined time in the past may be a time interval of one minute in the past. The relevant-event-selecting-method learning unit 123 determines at least the type of event data output from the information processing system 200 as well as the output time indicated by each event data. In addition, the relevant-event-selecting-method learning unit 123 determines a value indicated by each event data in the time interval.

In the initial stage of learning of the relevant-event-selecting model, the relevant-event-selecting-method learning unit 123 randomly selects multiple types of events among types of events in a certain time interval in the past (step S15). As a degree of learning of the relevant-event-selecting model progresses, the relevant-event-selecting-method learning unit 123 inputs into the relevant-event-selecting model the type of each event in a certain time interval and an event-emerging interval which can be calculated according to event-output times, thus selecting multiple types of events resulting from the relevant-event-selecting model. The relevant-event-selecting model is a learning model for outputting the event type having high relevancy among multiple types of events output from the information processing system 200 in time intervals.

The relevant-event-selecting-method learning unit 123 inputs into the relevant-event-selecting model the type of each event in a certain time interval, an event-emerging interval which can be calculated according to event-output times, and the current value of process data as well as a process value of process data or a process value of event data which is calculated based on process data, thus selecting multiple types of events resulting from the relevant-event-selecting model.

The relevant-event-selecting-method learning unit 123 may input into the relevant-event-selecting model other information than the above information, thus selecting multiple types of events resulting from the relevant-event-selecting model. For example, it is possible to further input into the relevant-event-selecting model a value of prediction accuracy resulting from the event-series prediction unit 140, which will be described later, thus selecting multiple types of events resulting from the relevant-event-selecting model.

It will be described later that the relevant-event-selecting-method learning unit 123 may perform learning for the relevant-event-selecting model to increase a value of prediction accuracy resulting from the event-series prediction unit 140. This makes it possible for the relevant-event-selecting-method learning model 123 to generate a learning model for outputting the event type having high relevancy among multiple types of events output from the information processing system 200 in the time interval. Herein, high relevancy can be defined as a high possibility of the event type to be output in the future time interval. The relevant-event-selecting-method learning unit 123 outputs to the event-series-predicting-method learning unit 124 the information representing the selected time interval and the event type selected in the time interval. The relevant-event-selecting-method learning unit 123 sets a plurality of different time intervals so as to similarly select multiple types of events per each time interval, thus outputting multiple types of events to event-series-predicting-method learning unit 124.

The event-series-predicting-method learning unit 124 acquires the information of the time interval output from the relevant-event-selecting-method learning unit 123 as well as multiple types of events selected in the time interval. The event-series-predicting-method learning unit 124 inputs into the series prediction model the information of multiple types of events output from the relevant-event-selecting-method learning unit 123 in a certain time interval, thus predicting and outputting the information of the time interval and the order of event types which can be predicted to appear in the future time interval such as the next time interval to the time interval selected by the relevant-event-selecting-method learning unit 123 (step S16). That is, the series prediction model for inputting the selected types of events is a learning model configured to predict the time interval and the order of the selected types of events emerging in the future time interval. For example, the future time interval may be a time interval from the present time to a future time to be elapsed by a predetermined time length of one minute after the present time. Alternatively, when a reference time is set to be elapsed from the present time by a predetermined time, the future time interval may be a time interval from the present time to a future time to be elapsed from the reference time by a predetermined tine length of one minute after the reference time.

The event-series-predicting-method learning unit 124 may input into the series prediction model the values of process data corresponding to events included in the time interval set by the relevant-event-selecting-method learning unit 123 as well as process values of event data and process values of process data calculated based on process data, thus outputting the information of the time interval and the order of event types which are predicted to emerge in the future time interval such as the next time interval to the time interval selected by the relevant-event-selecting-method learning unit 123.

The event-series-predicting-method learning unit 124 may input other information than the above information to the series prediction model, thus determining the information of the time interval and the order of event types, which are predicted to emerge in the future time interval such as the next time interval to the time interval selected by the relevant-event-selecting-method learning unit 123, according to the output of the series prediction model. The event-series-predicting-method learning unit 124 determines the information of the time interval and the order of event types which are selected in each time interval set by the relevant-event-selecting-method learning unit 123 and predicted to emerge in the future time interval such as the next time interval to the selected time interval (step S17).

Subsequently, the event-series-predicting-method learning unit 124 may use formula (1) to calculate prediction accuracy R (step S18). The prediction accuracy R is produced according to a matching degree regarding the order of event types which are selected in the time interval and predicted to emerge in the future time interval and a matching degree regarding the future time interval subsequent to the time interval based on event-emerging times.

$$[ Formula 1 ]$$

$$= 𝔼 [ {\sum }_{i} ( {\sum }_{j} ( {e}_{ij}^{\hat{}} log {e}_{ij} ) - {λ ( {t}_{i}^{\hat{}} - {t}_{i} )}^{2} {\sum }_{j} ( {e}_{ij} {w}_{j} ) ) ] \qquad ( 1 )$$

In formula (1), symbol i denotes an event-emerging order in a time interval while symbol j denotes an event type. In formula (1), symbol eᵢⱼ denotes a probability in which the event type j emerges in order i in the time interval output from the event-series-predicting-method learning unit 124 using the series prediction model. In formula (1), symbol e\hat{ }ᵢⱼ is a value which is set to “1” if the event type j actually emerges in order i in the set time interval or the future time interval subsequent to the set time interval or “0” if not. In formula (1), symbol tᵢ denotes a time interval between an emerging time of an event i−1 in the time interval output from the event-series-selecting-method learning unit 124 using the series prediction model and an emerging time of an event i. In formula (1), symbol wⱼ is a weight value output from the event-series-selecting-method learning unit 124 using the series prediction model. In this connection, it is possible to omit the term of wj. In formula (1), symbol λ denotes a constant.

$$[ Formula 2 ]$$

$$\sum ( {e}_{ij}^{\hat{}} log {e}_{ij} ) \qquad ( 2 )$$

In the above, term (2) included in formula (1) represents a value (a numerical value) of prediction accuracy according to a matching degree between the order of events selected from event data in the time interval set by the relevant-event-selecting-method learning unit 123 and the order predicted by the event-series-predicting-method learning unit 124. The value produced by term (2) becomes larger as the matching degree becomes higher.

$$[ Formula 3 ]$$

$$- {λ ( {t}_{i}^{\hat{}} - {r}_{i} )}^{2} {\sum }_{j} ( {e}_{ij} {w}_{j} ) \qquad ( 3 )$$

In the above, term (3) included in formula (1) represents a value (a numerical value) of prediction accuracy according to a matching degree between the time interval for events selected from event data in the time interval set by the relevant-event-selecting-method learning unit 123 and the time interval for events predicted by the event-series-predicting-method learning unit 124. The value produced by term (2) becomes larger as the matching degree becomes higher.

The event-series-predicting-method learning unit 124 calculates the sum of term (2) and term (3) with respect to each time interval set by the relevant-event-selecting-method learning unit 123 so as to output the prediction accuracy R representing an average E therebetween. The event-series-predicting-method learning unit 124 outputs to the relevant-event-selecting-method learning unit 123 the prediction accuracy R which is calculated based on the output of the relevant-event-selecting-method learning unit 123.

Based on multiple types of events selected by event series representing at least a plurality of event types output from the information processing system 200 in the past time interval and the output times of events, the event-series-predicting-method learning unit 124 calculates a series prediction model, which is used to predict the order of event types output from the information processing system 200 in the future time interval and the time interval for outputting event types, by repeating the aforementioned processes via machine learning (step S19).

For the purpose of calculating the series prediction model, the event-series-predicting-method learning unit 124 may use any types of machine-learning methods, for example, it is possible to use machine-learning methods such as logistics regression, support-vector machine, perceptron, neural networks, decision trees, and rule extraction. In particular, the event-series-predicting-method learning unit 124 may use LSTM (Long-Short Term Memory) and Attention Mechanism, which serves as one types of neural networks, for calculating the series prediction model. In addition, the event-series-predicting-method learning unit 124 may use pattern mining methods such as A-priori algorithm, FP-Tree algorithm, FP-Growth algorithm, and Prefix-Span algorithm for calculating the series prediction model.

The relevant-event-selecting-method learning unit 123 stores multiple types of events selected, the prediction accuracy R according to the output thereof, and the information of the time interval subjected to a selecting process for selecting multiple types of events as well as event data and process data in the time interval, process values of event data, and process values of process data in association with each other.

According to the machine-learning method such as reinforcement learning, the relevant-event-selecting-method learning unit 123 calculates a relevant-event-selecting model for selecting relevant events from among types of events included in the time interval for setting multiple types of events causing an increasing value of the prediction accuracy R (step S20). That is, the relevant-event-selecting-method learning unit 123 repeats the learning process to select multiple types of events causing an increasing value of the prediction accuracy R according to the input/output relationship when outputting the prediction accuracy R output from the event-series-predicting-method learning unit 124 while inputting multiple types of events used to calculate the prediction accuracy R as well as process values of event data, process data, and process values of process data.

According to the aforementioned process, upon an input of event series representing at least multiple types of events output from the information processing system 200 in the past time interval and the output times of events, the relevant-event-selecting-method learning unit 123 generates by machine learning a relevant-event-selecting model for outputting multiple types of events causing an increasing value of the prediction accuracy to be higher as differences become smaller between prediction results, regarding the order of event types output from the information processing system 200 in the future time interval and the time interval for outputting event types, and the order of event types output from the information processing system 200 in the future time interval and the actual measurement of time interval for outputting event types.

For the purpose of calculating the relevant-event-selecting model, the relevant-event-selecting-method learning unit 123 may use any types of machine-learning methods, for example, it is possible to use machine-learning methods such as logistics regression, support-vector machine, perceptron, neural networks, decision trees, and extraction of rules. In particular, the relevant-event-selecting-method learning unit 123 may use LSTM (Long-Short Term Memory) and Attention Mechanism, which serve as one types of neural networks, for calculating the relevant-event-selecting model. In addition, the relevant-event-selecting-method learning unit 123 may use pattern mining methods such a A-priori algorithm, FP-Tree algorithm, FP-Growth algorithm, and Prefix-Span algorithm for calculating the relevant-event-selecting model.

The event-series-predicting-method learning unit 124 outputs to the model update unit 125 a group of parameters constituting the series prediction model after updating. The model update unit 125 stores on the model storage unit 170 various data of the series prediction model including a group of parameters constituting the series prediction model after updating (step S21).

The relevant-event-selecting-method learning unit 123 outputs to the model update unit 125 a group of parameters constituting the relevant-event-selecting model after updating. The model update unit 125 stores on the model storage unit 170 various data of the relevant-event-selecting model including a group of parameters constituting the relevant-event-selecting model after updating (step S22).

According to the aforementioned process, the relevant-event-selecting-method learning unit 123 cooperates with the event-series-predicting-method learning unit 124 to generate a relevant-event-selecting model for selecting a certain type relevant to multiple events among events emerging in a certain time interval. According to the aforementioned process using an event type selected in a certain time interval, event data and process data included in event series in the time interval as well as process values of event data and process values of process data, it is possible to generate a series prediction model for predicting the order of event types output from the information processing system 200 in the future time interval and the time interval for outputting event types.

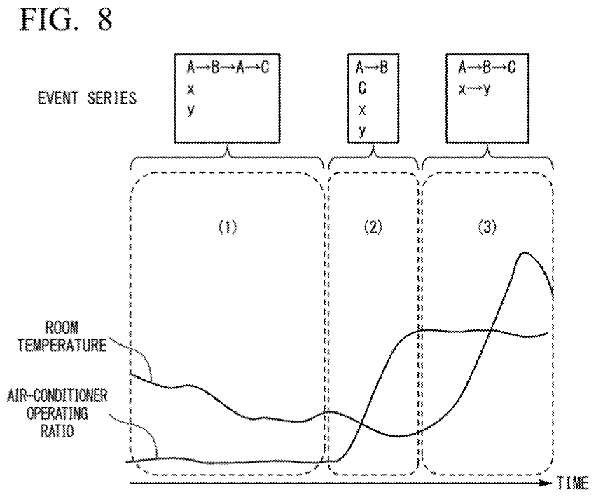

FIG. 8 is a graph showing the relationship between the process state and the event series.

As shown in FIG. 8, the aforementioned time intervals may exemplify the time intervals which are set in various process states output from the information processing system 200 such as process state (1), process state (2), and process state (3). As shown in FIG. 8, characteristics relating to process data (e.g., room temperature, air-conditioner operating rate, etc.) and event series representing time intervals and the order of event data output from the information processing system 200 may be frequently differentiated with respect to each process state. In this connection, the process state may be physical information measured by sensors in the information processing system 200. In addition, the process state may be represented by the information relating to the system-operating status such as the state just after the information processing system 200 starts to operate and the normal operation state. The aforementioned processes are used to generate a series prediction model configured to accurately predict the time interval and the order of event types emerging in the future time interval in a period of continuing the process state determined by the information output from the information processing system 200, and a relevant-event-selecting model for selecting multiple types of events having the series prediction model performed prediction. According to the aforementioned processes, it is possible to generate a series prediction model configured to accurately predict the time interval and the order of event types emerging in the future time interval without detecting the current process state and a relevant-event-selecting model for selecting multiple types of events having the series prediction model performed prediction. The process state is one example of state information. Of course, it is possible to set the time interval completely irrelevant to the above process state. For example, time can be equally sliced in units of one minute, thus setting the time interval for one minute. In this connection, it is possible to extract features representing the unknown process, which cannot be determined actually, solely using event series and process data without using the information relating to the process state, and therefore it is possible to perform learning of the relevant-event-selecting model and the series prediction model, thus making it possible to select event types responsive to the unknown process state and to estimate the time interval and the order of event types.

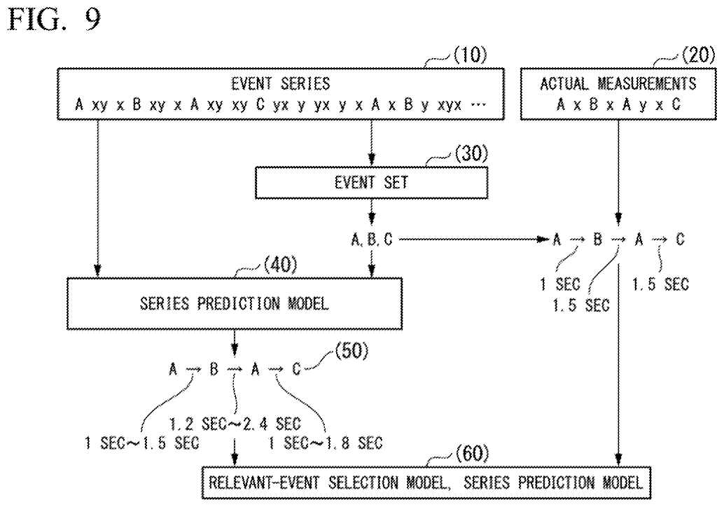

FIG. 9 is a block diagram showing an outline of processing of the learning unit. As shown in FIG. 9, the learning unit 120 inputs into a series prediction model (40) event series (10) representing types of events emerging in the time interval set in step S14 and an event set (30) representing at least multiple types of events selected from among events included in the event series. Using the series prediction model, the learning unit 120 calculates prediction results (50) representing the time interval and the order of event types emerging in the future time interval. Based on the prediction results (50) and actual measurements (20), the learning unit 120 calculates a relevant-event-selecting model and a series prediction model via machine learning (60) to update them.

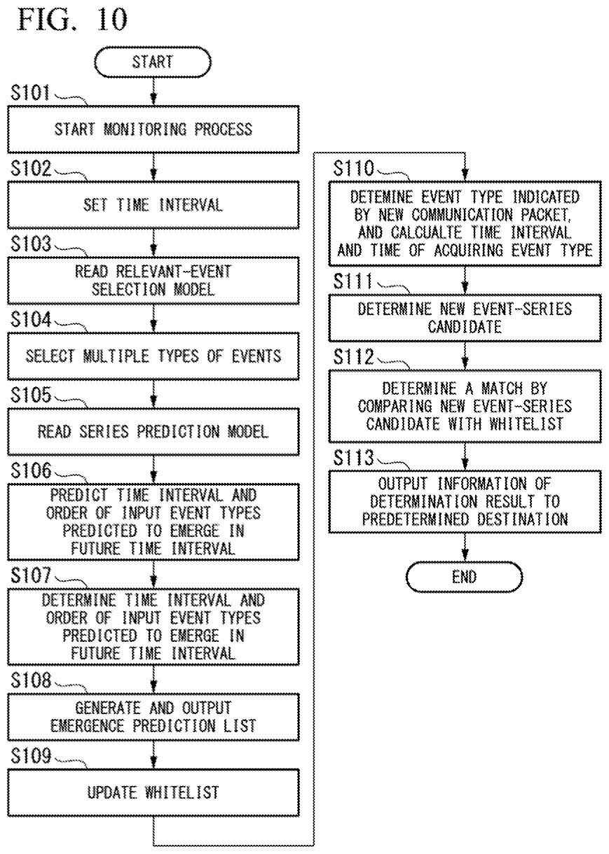

FIG. 10 is a second flowchart showing a flow of processing of the information processing device.

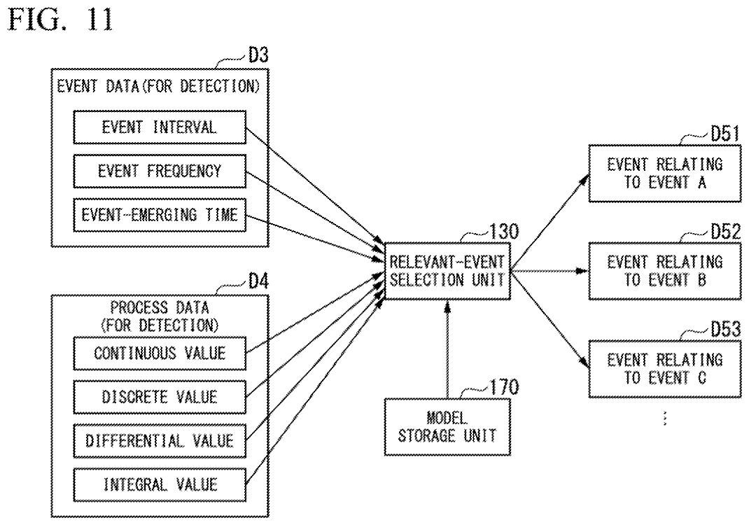

FIG. 11 is a block diagram showing an outline of processing in a monitoring process.

Hereinafter, the monitoring process of the information processing device 10 will be described in detail.

After improving accuracy of learning models (e.g., a relevant-event-selecting model, a series prediction model) by repeating the aforementioned learning process, the information processing device 100 starts to perform the monitoring process for monitoring abnormality of a control subject such as a plant according to communication packets output from the information processing system 200 (step S101). In the monitoring process, the relevant-event selection unit 130 sets a predetermined time interval including the present time (step S102). The relevant-event selection unit 130 acquires event data D3 and process data D4 in the predetermined time interval including the present time. As the predetermined time including the present time, for example, the relevant-event selection unit 130 may set a time interval based on the present time for one minute in the past. Alternatively, as the predetermined time including the present time, the relevant-event selection unit 130 may set a time interval based on the present time for one minute in the future. In this connection, a user may arbitrarily set a time length of the predetermined time based on the present time. For example, the time length may be equal to the time length set in the learning process.

The relevant-event selection unit 130 reads the relevant-event-selecting model recorded on the model storage unit 170 (step S103). The relevant-event selection unit 130 acquires event series representing at least multiple types of events output from the information processing system 200 in the set time interval in the past and output times of events. The relevant-event selection unit 130 inputs into the relevant-event-selecting model multiple types of events included in the set time interval and an event-emerging interval which can be calculated according to output times of events. The relevant-event selection unit 130 selects multiple types of events output from the relevant-event-selecting model (step S104).

In addition, the relevant-event selection unit 130 inputs into the relevant-event-selecting model multiple types of events included in the set time interval and the event-emerging interval which can be calculated according to output times of events as well as current values of process data, process values of process data or process values of event data which are calculated based on process data. As a result, the relevant-event selection unit 130 selects multiple types of events output from the relevant-event-selecting model. The relevant-event selection unit 130 outputs to the event-series prediction unit 140 multiple types of selected events (or an event set) and the information representative of the set time interval.

When an event type determined by a new communication packet in the set time interval relates to event A, as shown in FIG. 11, the relevant-event selection unit 130 outputs a combination of event types (or an event set) including event type A and other event types having high relevance to events of event type A which may possibly emerge in the future event series. In addition, when an event type determined by a new communication packet in the set time interval relates to event B, as shown in FIG. 11, the relevant-event selection unit 130 outputs a combination of event types (or an event set) including event type B and other event types having high relevance to events of event type B which may possibly emerge in the future event series. Moreover, when an event type determined by a new communication packet in the set time interval relates to event C, as shown in FIG. 11, the relevant-event selection unit 130 outputs a combination of event types (or an event set) including event type C and other event types having high relevance to events of event type C which may possibly emerge in the future event series.

The event-series prediction unit 140 sequentially acquire the information of event series in the time interval set by the relevant-event selection unit 130. In addition, the event-series prediction unit 140 acquires multiple types of events (or an event set) from the relevant-event selection unit 130. The event-series prediction unit 140 reads the series prediction model which is recorded on the model storage unit 170 in association with the identification information of the process state serving as the current control subject (step S105).

The event-series prediction unit 140 acquires the information of the time interval set by the relevant-event selection unit 130 and types of events selected in the time interval (e.g., an event set). The event-series prediction unit 140 inputs into the series prediction model multiple types of events output from the relevant-event selection unit 130 in its set time interval. As a result, the event-series prediction unit 140 predicts and outputs the information of the time interval and the order of event types which may emerge in the future time interval such as the next time interval to the time interval set by the relevant-event selection unit 130 (step S106). For example, the future time interval may be a time interval having a predetermined time length of one minute elapsed after the present time, or the future time interval may be a time interval having a predetermined time length of one minute elapsed after a reference time to be set a predetermined time after the present time. The time interval should be equal to the future time interval which is set with reference to the reference time in the learning process.

The event-series prediction unit 140 may input into the series prediction model various values of process data corresponding to events included in the time interval set by the relevant-event selection unit 130 as well as process values of event data and process values of process data which are calculated based on process data, thus outputting the information of the time interval and the order of event types which are predicted to emerge in the future time interval such as the next time interval to the time interval selected by the relevant-event selection unit 130.

The event-series prediction unit 140 may input other information than the aforementioned information into the series prediction model, thus outputting the information of the time interval and the order of event types which are predicted to emerge in the future time interval such as the next time interval to the time interval selected by the relevant-event selection unit 130 based on the output of the series prediction model. The event-series prediction unit 140 determines the information of the time interval and the order of event types which are predicted to emerge in the future time interval such as the next time interval to the selected time interval with respect to each time interval set by the relevant-event selection unit 130 (step S107). The event-series prediction unit 140 generates an emergence prediction list representing at least the time interval and the order of the selected events which may emerge in the future, thus outputting the emergence prediction list to the event-series monitoring unit 150 (step S108).

The event-series prediction unit 140 may learn and predict using a probability model the order and the time interval, e.g., the order of events in event series and the time interval between events in event series, thus outputting a range of time intervals causing high prediction probability exceeding its threshold value. The probability model can be formed according to any methods, for example, it is possible to assume an arbitrary probability distribution. For example, it is possible to use a discrete distribution, a binomial distribution, a polynomial distribution, a Gaussian distribution, a Laplace distribution, a t-distribution, a Cauchy distribution, a Gumbel distribution, a Poisson distribution, a Levy distribution, a q-Gaussian distribution, or the like. In addition, it is possible to use probability models not assuming a single distribution such as mixture models and nonparametric Bayes. In this case, the event-series prediction unit 140 generates an emergence prediction list covering a range of time intervals calculated, thus outputting the emergence prediction list to the event-series monitoring unit 150.

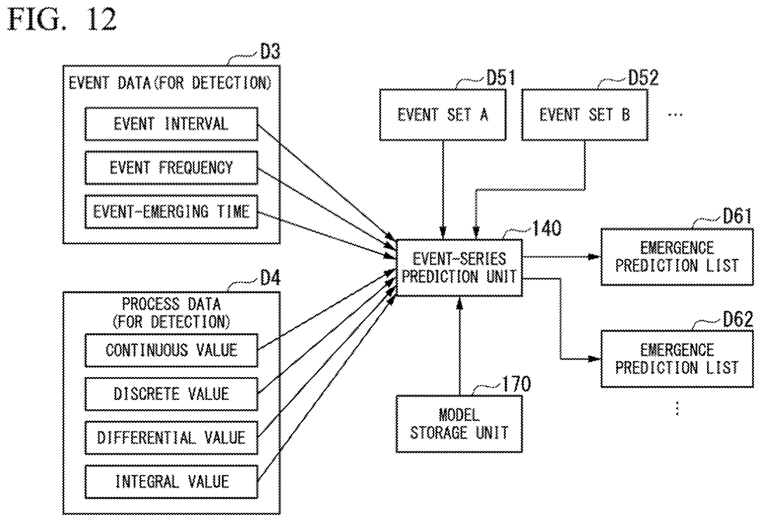

FIG. 12 is a second block diagram showing an outline of processing of a monitoring process.

When an event type determined by a new communication packet in the set time interval relates to event A, as shown in FIG. 12, the event-series prediction unit 140 inputs from the relevant-event selection unit 130 a combination of event types (or event set A) including event type A and other event types having high relevance to events of event type A which may emerge in the future event series (D51). In addition, when an event type determined by a new communication packet in the set time interval relates to event B, the event-series prediction unit 140 inputs from the relevant-event selection unit 130 a combination of event types (or event set B) including event type B and other event types having high relevance to events of event type B which may emerge in the future event series (D52).

According to the event-series prediction model using even-series candidates (D51) representing at least the time interval and the order of events which are selected by the relevant-event selection unit 130 and which may emerge in the future, the event-series prediction unit 140 outputs a emergence list (D61) representing the time interval and the order of events which may emerge in the future. According to the event-series prediction model using event-series candidates (D52) representing at least the time interval and the order of events which are selected by the relevant-event selection unit 130 and which may emerge in the future, the event-series prediction unit 140 outputs an emergence list (D62) representing the time interval and the order of events which may emerge in the future.

Upon acquiring the emergence prediction list representing the time interval and the order of events which may emerge in the future from the event-series prediction unit 140, the event-series monitoring unit 150 updates a whitelist describing the above pieces of information with the information of the newly-acquired emergence prediction list including the time interval and the order of event types (step S109).

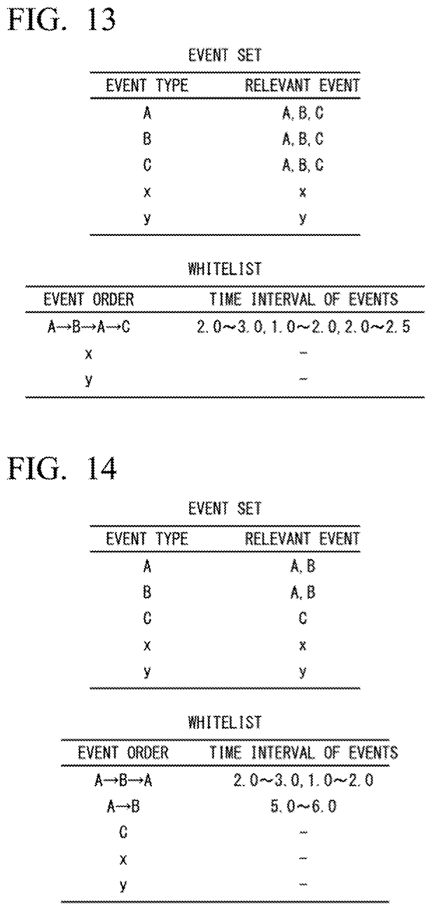

FIG. 13 includes a pair of tables showing the relationship between a whitelist and an event set in a first process state.

When the process state refers to process state (1) shown in FIG. 8, as shown in FIG. 13, the relevant-event selection unit 130 selects highly-relevant event types A, B, C, thus outputting an event set including the event types A, B, C to the event-series prediction unit 140. Based on the event set, the event-series prediction unit 140 generates a whitelist describing an emergence order of A→B→A→C and time intervals between events in the emergence order.

FIG. 14 includes a pair of tables showing the relationship between a whitelist and an even set in a second process state.

When the process state refers to process state (2) shown in FIG. 8, as shown in FIG. 14, the relevant-event selection unit 130 selects highly-relevant event types A, B, thus outputting an event set including the event types A, B to the event-series prediction unit 140. Based on the event set, the event-series prediction unit 140 generates a whitelist describing an emergence order of A→B→A and an emergence order of A→B and time intervals between events in the emergence orders.

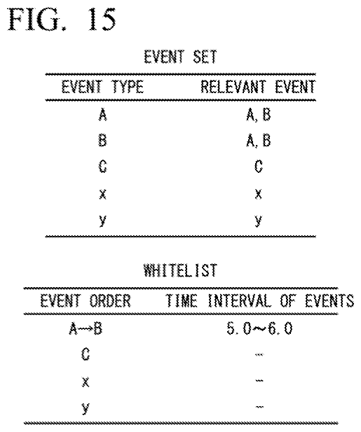

FIG. 15 includes a pair of tables showing the relationship between a whitelist and an event set in a third process state.

When the process state refers to process state (3) shown in FIG. 8, as shown in FIG. 15, the relevant-event selection unit 130 selects highly-relevant event types A, B, thus outputting an event set including the event types A, B to the event-series prediction unit 140. Based on the event set, the event-series prediction unit 140 generates a whitelist describing an emergence order of A→B and the time interval between events in the emergence order.

Upon acquiring each communication packet, the event-series monitoring unit 15 determines an event type indicated by a new communication packet, thus calculating a time interval between the time of acquiring the event type and the time of acquiring the emerging event type (step S110). The event-series monitoring unit 15 determines a new event-series candidate including the time interval and the time of acquiring the emerging event type which are calculated based on communication packets acquired from the information processing system 200 in a new period from the present time to its subsequent time which is a predetermined time after the present time (step S111). The event-series monitoring unit 15 compares the new event-series candidate with event-series candidate including event types and time intervals described in the whitelist, thus determining a match therebetween (step S112). When matched, the event-series monitoring unit 15 determines that the monitoring subject is normal. When unmatched, the event-series monitoring unit 15 determines that the monitoring object is abnormal. The event-series monitoring unit 15 outputs its determination result indicating either normality or abnormality to a predetermined destination (step S113). When the determination result indicates abnormality, the event-series monitoring unit 15 may output an alarm.

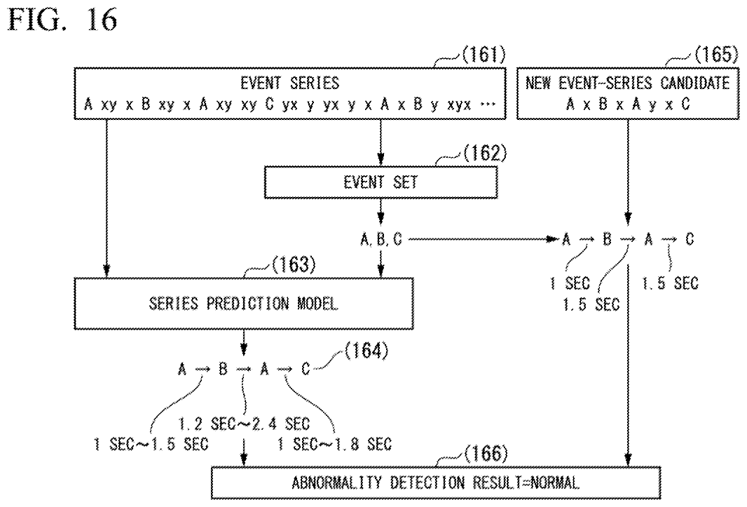

FIG. 16 is a block diagram showing an example of the monitoring process whose determination result indicates normality.

As shown in FIG. 16, the relevant-event selection unit 130 inputs into a series prediction model (163) event series (161) representing types of events emerging in the set time interval in a time-series manner and an event set (162) representing multiple types of events selected from among events included in the event series (161). According to the series prediction model, the event-series prediction unit 140 calculates a prediction result (e.g., an event-series candidate 164) representing the order of event types emerging in the future time interval and time intervals therebetween. The event-series monitoring unit 15 determines that the information processing system 200 serving as a monitoring subject is normal due to a high matching degree between the event-series candidate (164) and the new event-series candidate (165).

The event-series prediction unit 140 may output the event-series candidate 164 including various pieces of information, e.g., an emergence order of event types of A→B→A→C as well as a time interval of A→B ranging between 1-1.5 seconds, a time interval of B→A ranging between 1.2-2.4 seconds, and a time interval of A→C ranging between 1-1.8 seconds in the emergency order of event types. In addition, the event-series monitoring unit 15 may determine the new event-series candidate (165) including various pieces of information, e.g., an emergence order of event types of A→x→B→x→A→y→x→C as well as a time interval of A→B of 1 second, a time interval of B→A of 1.5 seconds, and a time interval of A→C of 1.5 seconds in the emergence order of event types. In this case, the event-series monitoring unit 15 determines normality due to a high matching degree relating to event types included in the event-series candidate and their emergence order as well as time interval between event types (166).

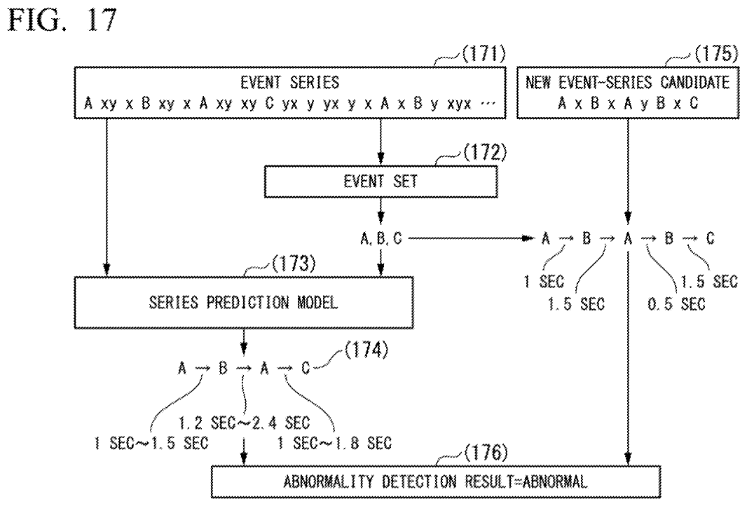

FIG. 17 is a block diagram showing an example of the monitoring process whose determination result indicates abnormality.

As shown in FIG. 17, the relevant-event selection unit 130 inputs into a series prediction model (173) event series (171) representing types of events emerging in the set time interval in a time-series manner and an event set (172) representing multiple types of events selected from among events included in the event series (171). According to the series prediction model, the event-series prediction unit 140 calculates a prediction result (e.g., an event-series candidate 174) representing the order of event types emerging in the future time interval and time intervals therebetween. The event-series monitoring unit 15 determines that the information processing system 200 serving as a monitoring subject is normal due to a high matching degree between the event-series candidate (174) and the new event-series candidate (175).

The event-series prediction unit 140 may output the event-series candidate 174 including various pieces of information, e.g., an emergence order of event types of A→B→A→C as well as a time interval of A→B ranging between 1-1.5 seconds, a time interval of B→A ranging between 1.2-2.4 seconds, and a time interval of A→C ranging between 1-1.8 seconds in the emergency order of event types. In addition, the event-series monitoring unit 15 may determine the new event-series candidate (175) including various pieces of information, e.g., an emergence order of event types of A→x→B→x→A→y→B→x→C as well as a time interval of A→B of 1 second, a time interval of A→B of 0.5 seconds, and a time interval of B→C of 1.5 seconds in the emergence order of event types. In this case, the event-series monitoring unit 15 determines abnormality due to a low matching degree relating to event types included in the event-series candidate and their emergence order as well as time interval between event types (176).

According to the present exemplary embodiment as described above, the information processing device 100 acquires event series representing at least multiple type of events output from the information processing system 200 in the past time interval and output times of events. Upon an input of the event series, the information processing device 100 may generate a selection model for outputting multiple types of events via machine learning with a prediction accuracy to be improved due to smaller differences between prediction results, which relate to the order of event types output from the information processing system 200 in the future time interval and time intervals of outputting event types, and actual measurements relating to the order of event types output from the information processing system 200 in the future time interval and time intervals of outputting event types. Based on at least multiple types of the selected events, the information processing device 100 may generate a series prediction model via machine learning, which is designed to predict the order of event types output from a target system in the future time interval and time intervals for outputting event types. Using the aforementioned learning models, the information processing device 100 is configured to predict the order of event types, which may highly-likely emerge in the time interval set at the present time or in the present process state either any process states determined by process data and event types of communication packets acquired from the information processing system 200 or unknown process states which cannot be determined. The information processing device 100 is configured to determine normality or abnormality in the system output based on prediction results and actual measurements, and therefore it is possible to accurately monitor abnormality in the control subject regardless of process states.

According to the aforementioned processes, even when a target system such as the information processing system 200 outputs event data including plenty of different event types, it is possible to predict the order of event types, which may be highly-likely outputted in the future time interval in similar process states, and time intervals therebetween by simply selecting types of event data having high relevance among event data.

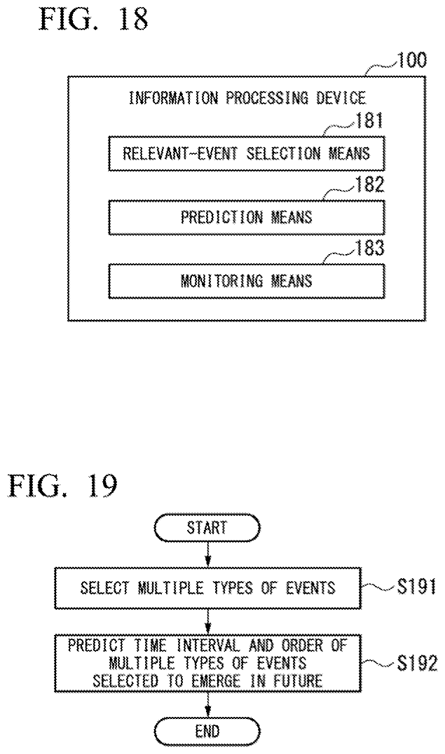

FIG. 18 is a block diagram showing the minimum configuration of an information processing device.

FIG. 19 is a flowchart showing a flow of processing of the information processing device having the minimum configuration.

The information processing device 100 needs to include at least a relevant-event selection means 181, a prediction means 182, and a monitoring means 183.

Using event series representing at least multiple types of events output from a target system (e.g., the information processing system 200) in the past time interval and output times of events as well as a relevant-event selection model for selecting event types having a high emergence probability which may emerge in the future from among the event types included in the event series, the relevant-event selection means 181 may select event types having a high emergence probability which may emerge in the future from among the event types included in the event series (step S191).

The prediction means 182 predicts the order of the selected events which may emerge in the future and time intervals therebetween by use of a series prediction model for estimating multiple types of the selected events, the order of the selected events which may emerge in the future, and time intervals therebetween (step S192).

The aforementioned information processing device 100 includes a computer system therein. The aforementioned processes are stored on computer-readable storage media in the form of programs; hence, a computer may read and execute programs to achieve the foregoing processes. Herein, computer-readable storage media refer to magnetic disks, magneto-optical disks, CD-ROM, DVD-ROM, semiconductor memory or the like. In addition, it is possible to deliver computer programs to a computer through communication lines, and therefore the computer receiving programs delivered thereto may execute programs.

The foregoing programs may achieve some of the foregoing functions. Alternatively, the foregoing programs may be differential files (or differential programs) which can realize the foregoing functions when combined with programs pre-stored on the computer system.

Part of or the entirety of the foregoing embodiments can be defined by the following appendixes, which may not necessarily be construed as limitations.

### APPENDIX 1

An information processing device includes a relevant-event selection means configured to use event series representing at least multiple types of events output from a target system in the past time interval and output times of events and a selection model configured to select event types to emerge in the future with high emergence probability among multiple types of events included in the event series and to thereby select a plurality of event types associated with a plurality of events which emerge in the future with the high emergence probability from among multiple types of events included in the event series, and a prediction means configured to predict an order of the selected events to emerge in the future and time intervals therebetween by use of the selected event types and a prediction model configured to estimate the order of the selected events to emerge in the future and the time intervals therebetween.

### APPENDIX 2

The information processing device according to Appendix 1, in which the prediction means is configured to generate an emergence prediction list representing at least the order of the selected events to emerge in the future and the time intervals therebetween, further includes a monitoring means configured to determine whether or not the target system outputs normal events based on combinations of the order of the selected events to emerge in the future and the time intervals of events as well as an order of events newly output from the target system and time intervals between events.

### APPENDIX 3

The information processing device according to Appendix 1 or Appendix 2 further includes a prediction-model learning means configured to generate a predictive model via machine learning to predict an order of event types to be output from the target system in the future time interval and time intervals for outputting event types based on a plurality of event types selected from the event series representing at least multiple types of events output from the target system in the past time interval and the output times of events.

### APPENDIX 4

The information processing device according to Appendix 3 further includes a selection-model learning means, upon inputting the event series representing at least multiple types of events output from the target system in the past time interval and the output times of events, configured to generate a selection model via machine learning to output multiple event types while improving a prediction accuracy as differences become smaller between prediction results, relating to the order of event types to be output from the target system in the future time interval and the time intervals for outputting event types, and actual measurements relating to the order of event types to be output from the target system in the future time interval and the time intervals for outputting event types.

### APPENDIX 5

In the information processing device according to Appendix 4, the prediction-model learning means is configured to calculate the prediction accuracy based on differences between the prediction results and the actual measurements.

### APPENDIX 6

In the information processing device according to Appendix 4, upon inputting the prediction accuracy, the selection-model learning means is configured to generate the selection model via machine learning to output multiple types of events while improving the prediction accuracy as differences between the prediction results and the actual measurements become smaller.

### APPENDIX 7

An information processing method includes the steps of: by use of event series representing at least multiple types of events output from a target system in the past time interval and output times of events and a selection model configured to select event types to emerge in the future with high emergence probability among multiple types of events included in the event series, selecting a plurality of event types associated with a plurality of events which emerge in the future with high emergence probability from among multiple types of events included in the event series; and predicting an order of the selected events to emerge in the future and time intervals therebetween by use of the selected event types and a prediction model configured to estimate the order of the selected events to emerge in the future and the time intervals therebetween.

### APPENDIX 8

A recording medium is configured to record programs causing a computer of an information processing device to function as: a relevant-event selection means configured to use event series representing at least multiple types of events output from a target system in the past time interval and output times of events and a selection model configured to select event types to emerge in the future with high emergence probability among multiple types of events included in the event series and to thereby select a plurality of event types associated with a plurality of events which emerge in the future with high emergence probability from among multiple types of events included in the event series; and a prediction means configured to predict an order of the selected events to emerge in the future and time intervals therebetween by use of the selected event types and a prediction model configured to estimate the order of the selected events to emerge in the future and the time intervals therebetween.

### APPENDIX 9

An information processing system includes a relevant-event selection means configured to use event series representing at least multiple types of events output from a target system in the past time interval and output times of events and a selection model configured to select event types to emerge in the future with high emergence probability among multiple types of events included in the event series and to thereby select a plurality of event types associated with a plurality of events which emerge in the future with high emergence probability from among multiple types of events included in the event series, and a prediction means configured to predict an order of the selected events to emerge in the future and time intervals therebetween by use of the selected event types and a prediction model configured to estimate the order of the selected events to emerge in the future and the time intervals therebetween.

### REFERENCE SIGNS LIST

100 . . . information processing device
110 . . . data measurement unit
120 . . . learning unit (selection-model learning means, prediction-model learning means)
130 . . . relevant-event selection unit (relevant-event selection means)
140 . . . event-series prediction unit (prediction means)
150 . . . event-series monitoring unit (monitoring means)
160 . . . data storage unit
170 . . . model storage unit
200 . . . information processing system

What is claimed is:

1. An information processing device comprising:
a relevant-event selection means configured to use event series representing at least multiple types of events output from a target system in a past time interval and output times of events and a selection model configured to select event types to emerge in a future with high emergence probability among the multiple types of events included in the event series and to thereby select a plurality of event types associated with a plurality of events which emerge in the future with the high emergence probability from among the multiple types of events included in the event series; and
a prediction means configured to predict an order in the selected plurality of events to emerge in the future and time intervals therebetween by use of the selected plurality of event types and a prediction model configured to estimate the order in the selected plurality of events to emerge in the future and the time intervals therebetween.

2. The information processing device according to claim 1, wherein the prediction means is configured to generate an emergence prediction list representing at least the order in the selected plurality of events to emerge in the future and the time intervals therebetween, the information processing device further comprising a monitoring means configured to determine whether or not the target system outputs normal events based on combinations of the order in the selected plurality of events to emerge in the future and the time intervals of events as well as an order of events newly output from the target system and time intervals between events.

3. The information processing device according to claim 1, further comprising a prediction-model learning means configured to generate a predictive model via machine learning to predict an order of event types to be output from the target system in a future time interval and time intervals for outputting the event types based on a plurality of event types selected from the event series representing at least the multiple types of events output from the target system in the past time interval and the output times of events.

4. The information processing device according to claim 3, further comprising a selection-model learning means, upon inputting the event series representing at least the multiple types of events output from the target system in the past time interval and the output times of events, configured to generate a selection model via machine learning to output the multiple event types while improving a prediction accuracy as differences become smaller between prediction results, relating to the order of event types to be output from the target system in the future time interval and the time intervals for outputting the event types, and actual measurements relating to the order of event types to be output from the target system in the future time interval and the time intervals for outputting the event types.

5. The information processing device according to claim 4, wherein the prediction-model learning means is configured to calculate the prediction accuracy based on the differences between the prediction results and the actual measurements.

6. The information processing device according to claim 4, wherein, upon inputting the prediction accuracy, the selection-model learning means is configured to generate the selection model via machine learning to output the multiple types of events while improving the prediction accuracy as the differences between the prediction results and the actual measurements become smaller.

7. An information processing method, comprising:
by use of event series representing at least multiple types of events output from a target system in a past time interval and output times of events and a selection model configured to select event types to emerge in a future with high emergence probability among the multiple types of events included in the event series, selecting a plurality of event types associated with a plurality of events which emerge in the future with the high emergence probability from among the multiple types of events included in the event series; and
predicting an order in the selected plurality of events to emerge in the future and time intervals therebetween by use of the selected plurality of event types and a prediction model configured to estimate the order in the selected plurality of events to emerge in the future and the time intervals therebetween.

8. A recording medium configured to record programs causing a computer of an information processing device to function as:
a relevant-event selection means configured to use event series representing at least multiple types of events output from a target system in a past time interval and output times of events and a selection model configured to select event types to emerge in a future with high emergence probability among the multiple types of events included in the event series and to thereby select a plurality of event types associated with a plurality of events which emerge in the future with the high emergence probability from among the multiple types of events included in the event series; and
a prediction means configured to predict an order in the selected plurality of events to emerge in the future and time intervals therebetween by use of the selected plurality of event types and a prediction model configured to estimate the order in the selected plurality of events to emerge in the future and the time intervals therebetween.

9. (canceled)

10. The information processing device according to claim 2, further comprising a prediction-model learning means configured to generate a predictive model via machine learning to predict an order of event types to be output from the target system in a future time interval and time intervals for outputting the event types based on a plurality of event types selected from the event series representing at least the multiple types of events output from the target system in the past time interval and the output times of events.
